(19) United States
(12) Patent Application Publication
(10) Pub. No.: US 2005/0246187 A1
(43) Pub. Date: Nov. 3, 2005

(54) System and method to facilitate differentiated levels of service in a network-based marketplace

(76) Inventor: Reed Maltzman, San Francisco, CA (US)

Correspondence Address: SCHWEGMAN, LUNDBERG, WOESSNER & KLUTH, P.A.;EBAY, P.O. BOX 2938, MINNEAPOLIS, MN, 55402-0938, US

(21) Appl. No.: 10/837,147

(22) Filed: Apr. 30, 2004

(51) Int. Cl. G06F 17/60

(52) U.S. Cl. 705/1; 705/37

(57) ABSTRACT

A method and a system to facilitate differentiated levels of service in a network-based marketplace are described. The system may include a transaction monitor to monitor activity of a user with respect to a network-based marketplace; a status generator to generate a status within the network-based marketplace, for the user based at least partially on the monitored activity; and a user service module to provide service within the network-based marketplace to the user in accordance with the determined status of the user. Users may achieve a preferred user status within the network-based marketplace. A preferred user may receive preview listings of items that are not available to users who did not achieve a preferred user status. A preferred user may also receive personalized customer service within the network-based marketplace.

### FIELD OF THE INVENTION

The present invention relates generally to the technical field of commerce automation and, in one exemplary embodiment, to methods and systems to facilitate differentiated levels of service in a network-based marketplace.

### BACKGROUND OF THE INVENTION

The advent of the Internet and the World Wide Web combined with the development of network-based marketplace applications has enabled companies to transact business globally in real time. In light of the growth of service trading within the network-based marketplace environment it is important for the service providers to encourage desirable behavior on the part of the consumers as well as to provide services efficiently. In order to accomplish these goals, the service providers may require information regarding the users, such as, for example, each user's transaction performance data.

Although some tracking of users' transaction performance ratings is presently conducted in select network-based marketplace environments, the collection of transaction feedback data has historically been difficult because a network-based marketplace environment may provide only the venue for trading, and may not be directly involved in the transaction once a product or service has been purchased. This has necessitated the development of data collection and data tracking capabilities beyond those normally available. Other technical challenges include the need to develop a means for sorting and processing large amounts of data related to transactions within the network-based marketplace, using database structures and mathematical algorithms, as well as a means for interpreting such data and creating differentiated levels of services.

Thus, it is desirable that service providers are enabled to differentiate between users in order to provide an appropriate level of service.

### SUMMARY OF THE INVENTION

According to one aspect of the present invention, there is provided a system to facilitate computer-based commerce. In one exemplary embodiment, the system includes a transaction monitor to monitor activity of a user with respect to a network-based marketplace; a status generator to generate a status within the network-based marketplace, for the user based at least partially on the monitored activity; and a user service module to provide service within the network-based marketplace to the user in accordance with the determined status of the user.

Other features of the present invention will be apparent from the accompanying drawings and from the detailed description, which follows.

### BRIEF DESCRIPTION OF THE DRAWINGS

The present invention is illustrated by way of example and not limited in the figures of the accompanying drawings, in which like references indicate similar elements and in which:

FIG. 1 is a network diagram depicting a system having a client-server architecture, according to one exemplary embodiment of the present invention.

FIG. 2 is a block diagram illustrating marketplace and payment applications according to one exemplary embodiment of the present invention.

FIG. 3 is a high-level entity-relationship diagram, illustrating various tables that may be utilized by and support the marketplace and payment applications, according to one embodiment of the present invention.

FIG. 4 is an illustration of the structures of the particular tables described in FIG. 3, according to one exemplary embodiment of the present invention.

FIG. 5 is a block diagram illustrating a system to facilitate differentiated levels of service according to one exemplary embodiment of the present invention.

FIG. 6 is a flow chart illustrating a method of updating the user status according to one exemplary embodiment of the present invention.

FIG. 7 is a flow chart illustrating a method of providing differentiated customer service, according to one exemplary embodiment of the present invention.

FIG. 8 is a flow chart illustrating a method of providing user interface to enable the user to preview listings, according to one exemplary embodiment of the present invention.

FIG. 9 is an exemplary user interface for a preferred user, according to one exemplary embodiment of the present invention.

FIG. 10 is a block diagram illustrating a computer system for performing the methods of the present invention according to one exemplary embodiment of the present invention.

### DETAILED DESCRIPTION

A method and system to facilitate differentiated levels of service in a network-based marketplace are described. In the following description, for purposes of explanation, numerous specific details are set forth in order to provide a thorough understanding of the present invention. It will be evident, however, to one skilled in the art that the present invention may be practiced without these specific details.

Platform Architecture

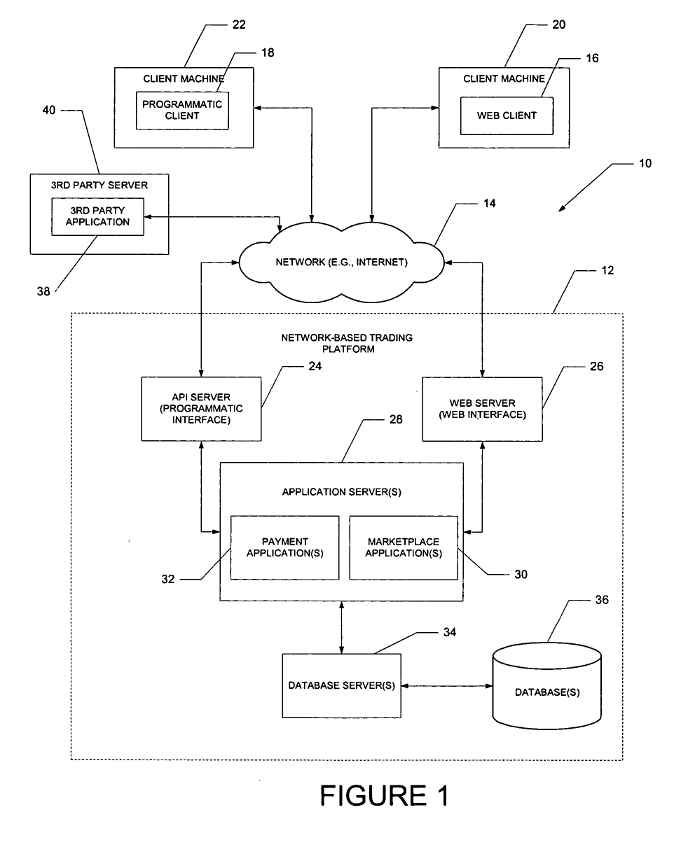

FIG. 1 is a network diagram depicting a system 10, according to one exemplary embodiment of the present invention, having a client-server architecture. A commerce platform, in the exemplary form of a network-based marketplace 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Washington State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the marketplace 12. The payment applications 32 likewise provide a number of payment services and functions to users. The payment applications 30 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32 are shown in FIG. 1 to both form part of the network-based marketplace 12, it will be appreciated that, in alternative embodiments of the present invention, the payment applications 32 may form part of a payment service that is separate and distinct from the marketplace 12.

Further, while the system 10 shown in FIG. 1 employs client-server architecture, the present invention is of course not limited to such architecture, and could equally well find application in a distributed, or peer-to-peer, architecture system. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

Marketplace Applications

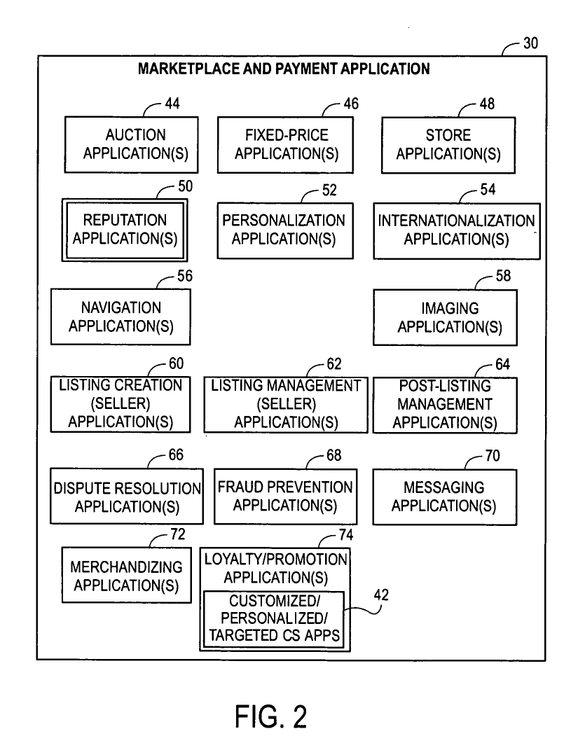

FIG. 2 is a block diagram illustrating multiple marketplace and payment applications 30 that, in one exemplary embodiment of the present invention, are provided as part of the network-based marketplace 12. The marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 to establish, build, and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based marketplace 12 over time. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

In one embodiment, the network-based marketplace 12 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network based-marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the marketplace 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 72 support various merchandising functions that are made available to sellers to enable sellers to increase sales via the marketplace 12. The merchandising applications 80 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed. In one exemplary embodiment, the one or more loyalty/promotions applications 74 may include a personalized customer support application 42, as well as a preferred customer listings application 43. The personalized customer support application 42 and the preferred customer listings application 43 may be implemented as stand alone applications or they may be incorporated in a single loyalty application.

Data Structures

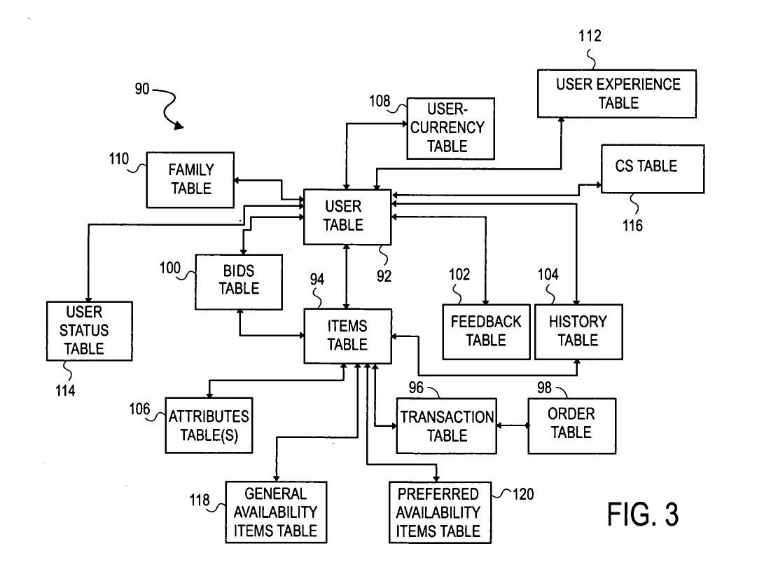

FIG. 3 is a high-level entity-relationship diagram, illustrating various tables 90 that may be maintained within the databases 36, and that are utilized by and support the marketplace and payment applications 30 and 32. A user table 92 contains a record for each registered user of the network-based marketplace 12, and may include identifier, address and financial instrument information pertaining to each such registered user. In addition to the user table 92, the databases 36 may maintain a user experience table 112 and a user status table 114 to store data that may be utilized in determination of the user's experience level and the user's loyalty status (e.g., a preferred user status). A user may, it will be appreciated, operate as a seller, a buyer, or both, within the network-based marketplace 12. In one exemplary embodiment of the present invention, a buyer may be a user that has accumulated value (e.g., commercial or proprietary currency), and is then able to exchange the accumulated value for items that are offered for sale by the network-based marketplace 12. It will be appreciated out that the information from the user status table 114 and the user experience table 112 may be combined into one table or even stored in the user table 92.

The tables 90 also include an items table 94 in which are maintained item records for goods and services that are available to be, or have been, transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in one exemplary embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

A customer support table 116 may include records, where in one exemplary embodiment each record is associated with a customer support request and an appropriate response according to a user's experience and/or a user's loyalty status.

In one exemplary embodiment, in addition to the items table 94, the database 36 may maintain a general availability items table 118 and a preferred availability items table 120. The preferred availability items table 120 may include records associated with one or more items that are only available to preferred users for viewing. In one exemplary embodiment of the present invention, the preferred availability items may become available to any user, irrespective of the user's loyalty status, after a predetermined period of time.

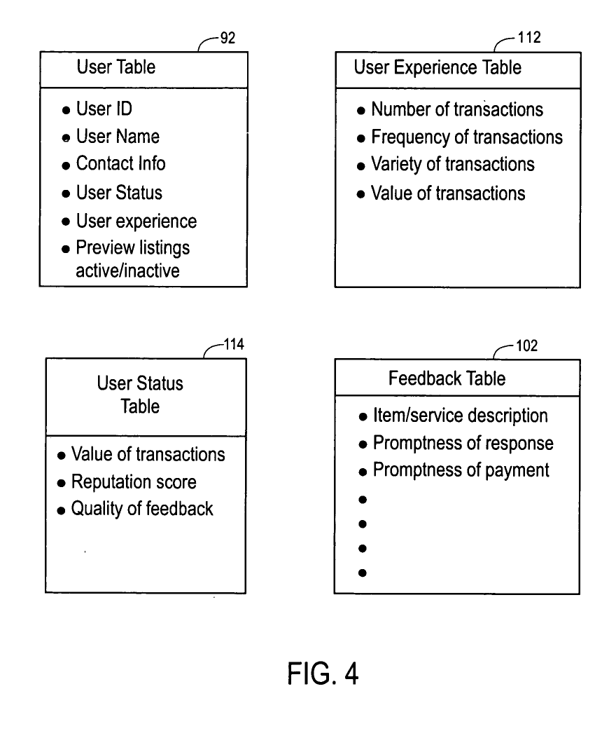

FIG. 4 is an illustration of the structures of the particular tables described in FIG. 3. In one exemplary embodiment of the present invention, a user table 92 may be implemented to store user information, including user ID, user name, contact information for the user, user loyalty status, and user experience. In one embodiment, a user's loyalty status may indicate that the user is a preferred user or a regular user. User status field may also be utilized to indicate user experience. In a further exemplary embodiment, the user table 92 may have separate fields for user status and user experience. The user table 92 may include information indicating whether a user, who is a preferred user, wishes to receive preview listings of goods and services. A preferred user may wish to take advantage of receiving the preview listings that are not available to regular users, in order to have a first choice of goods and services available within the electronic marketplace. In one exemplary embodiment, if a preferred user wishes to receive preview listings, the preview listings field may store a flag indicating that the preview listings feature is active. If, on the other hand, a preferred user does not wish to receive preview listings, the flag may be configured to indicate that the preview listings feature is inactive.

The user experience table 112 may be implemented to store user experience information, including the number of transactions in which the user was a participant, the frequency of transactions, the diversity of transactions, the value of transactions, and other criteria. Information stored in the user experience table 112 may be utilized to identify a user as an experienced user or as an inexperienced user, based on predetermined criteria. For example, the predetermined criteria may be simply a predetermined number of transactions, to which a user was a participant. In a further exemplary embodiment, a user may be identified as an experienced user based on a combination of factors such as the diversity of transactions, to which a user was a participant, and the complexity of each transaction. In one exemplary embodiment, each transaction may be identified as associated with a particular level of complexity.

The user status table 114 may be implemented to store information including the value of a transaction, the user's reputation score, the quality of feedback provided by the user, and other information. Information stored in the user status table 114 may be utilized to identify a user as a preferred user, or, for example, as a regular user. The feedback table 102 may be implemented to store information including an item description, a service description, promptness of response by a user who is a participant to the transaction, promptness of payment by the user, and other information.

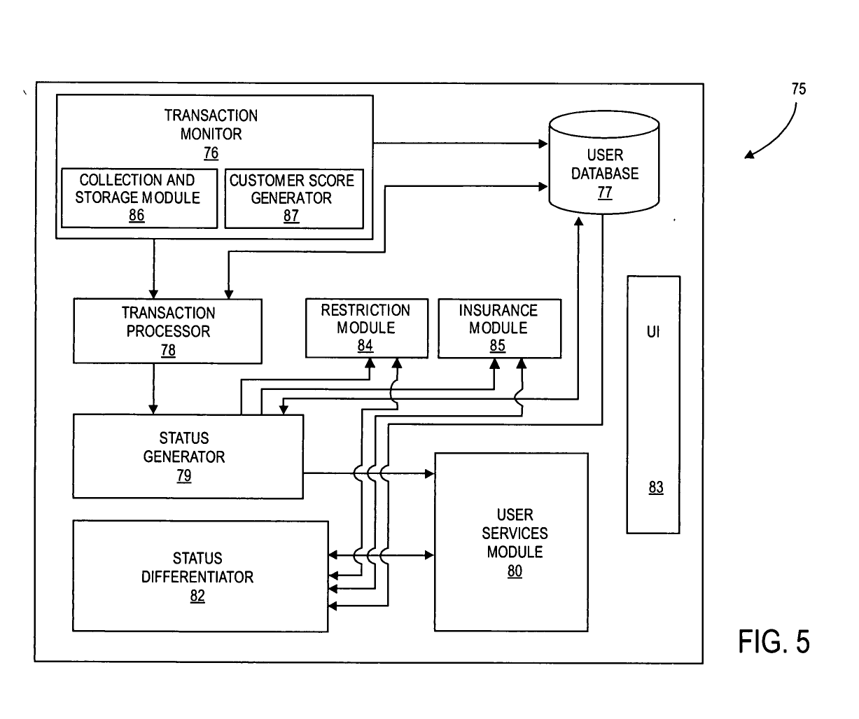

FIG. 5 is a block diagram illustrating a system 75 to facilitate differentiated levels of service according to one exemplary embodiment of the present invention. The system 75 may include components of the loyalty/promotion applications 74, the personalized customer support application 42, and the preferred customer listings application 43. The system 75 may include a transaction monitor 76, a user database 77, a transaction processor 78, a status generator 79, a user services module 81, a status differentiator 82, a user interface 83, a restriction module 84, and an insurance module 85. In one exemplary embodiment, the user database 77 may be included in the databases 36.

The transaction monitor 76 may be utilized to monitor marketplace and payment applications 30. The transaction monitor 76 may be configured to identify an active transaction, and monitor the transaction until the transaction is completed, cancelled, or deferred. In an alternative embodiment, the transaction monitor 76 may be configured to only identify information indicative of transaction completion. It may also be configured to communicate with the transaction processor 78. The transaction monitor 76 may include a collection and storage module 86 to collect user data reflecting activity of the user, and to store the user data within a database. The transaction monitor 76 may further include a customer score generator 87 to automatically generate a customer score utilizing the user data. The a customer score generator 87 may be configured to update a total number of transactions parameter and a value of transactions amount when a completed transaction is detected, to update a feedback score parameter when feedback regarding a transaction participant is detected, and to update a transaction frequency parameter.

The transaction processor 78 may receive information associated with the completed transaction from the transaction monitor 76. In an alternative embodiment, the transaction processor 78 may be configured to obtain such information from the payment and marketplace applications 30. Information associated with the completed transaction may include the value of the transaction, reputation information associated with one or more participants of the transaction, the type of the transaction, the level of complexity of the transactions, as well as other information.

Some of the information obtained in response to the completion of the transaction may be utilized in its raw form to update the user database 77. For example, the user database 77 may be configured to keep track of the total number of transactions, to which the user was a participant, by means of a transaction counter. In one exemplary embodiment, once a completed transaction for the user is identified, the transaction counter is updated to reflect the present number of completed transactions. The transaction processor 78 may also be configured (e.g., utilizing a customer score generator 87) to manipulate or process information obtained in response to the completion of the transaction, before it is utilized to update the user database 77. For example, a raw feedback score may be utilized to generate an adjusted feedback score for the user, where the adjusted feedback score is generated utilizing the tendency of the feedback provider to give predominantly negative feedback.

The transaction processor 78 may provide raw or processed information to the status generator 79. The status generator 79 may also obtain user data from the user database 77 and utilize such data to generate or update the user status for a user. The user status may be determined according to predefined criteria, such as the number of completed transactions, the total value exchanged by the user as a result of the completed transactions, the frequency of transactions, and other criteria. The user status generated by the status generator 79 may be stored in the user database 77. The user status information may be utilized by system 75 to provide differentiated services to users according to user experience, user loyalty, user reputation, and other criteria. In one embodiment, the status differentiator 82 may be configured to determine what level of service the user is entitled to, according to data generated by the status generator 79 and stored in the user database 77. The status differentiator 82 processes user status information to determine what level of services is appropriate for a particular user. The status differentiator 82 may also facilitate access to the appropriate level of services stored in the user services module 80, in the restriction module 84, and the insurance module 85. The user interface 83 is utilized to communicate with the user and to allow the user to interact with the system 75, for example, to obtain customer service.

Although the components of the system 75 are described as individual exemplary modules, the functionality of one or more exemplary modules may be combined in an alternative embodiment of the present invention. For example, the system 75 may be configured such that the functions performed by the transaction monitor 76 and the transaction processor 78 are performed by a single module.

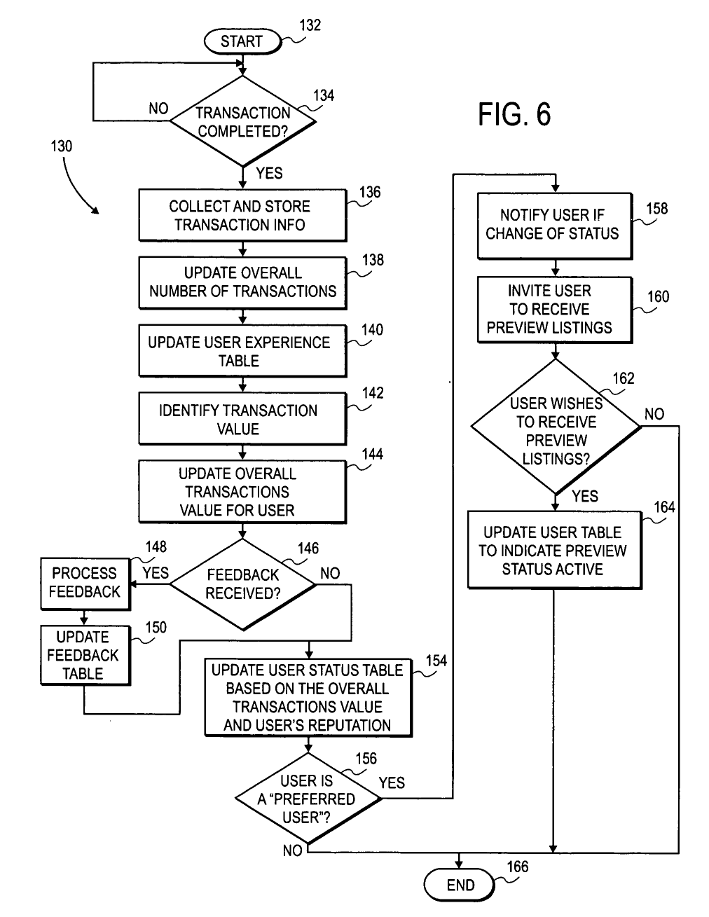

FIG. 6 is a flow chart illustrating a method 130 to update a user status. The method 130 commences at operation 132. At operation 134, the transaction monitor 76 determines whether the transaction is completed. If the transaction is completed at operation 136, the transaction processing module 78 collects transaction information and stores it in the user database 77. At operation 138, the overall number of transaction information is updated and the user experience table is updated at operation 140. At operation 142, the transaction value is identified. The overall transaction value for the user is updated at operation 144. At operation 146, the transaction monitor 76 determines whether the feedback has been received. If the feedback has been received, the transaction processor 78 processes the feedback at operation 148. The feedback table 102 is updated at operation 150. Information stored in the feedback table 102 may be utilized to generate a value associated with a user's reputation. At operation 154, the user status table 114 is updated according to the overall transactions value and the user's reputation.

Another criteria that may be utilized to determine a user's status is a safety score. A safety score may be determined utilizing one or more rules to identify a user as a more likely to be trustworthy or a less likely to be trustworthy. For example, if a person is located in a state that is considered by the system to be a higher risk state, (e.g., Russia may be considered to be a potential source of fraud and thus a higher risk state), the user being located in Russia may affect the determination of the user's status.

At operation 156, a determination is made whether the user is a preferred user. If the user is a preferred user, and if the user's status was changed to a preferred user status for the first time at operation 154, then the user is notified at operation 158 of the change of status. At operation 160, a user, who has achieved a preferred user status, is invited to receive preview listings. In one exemplary embodiment, if the user indicates that she wishes to receive preview listings at operation 162, then the user table 92 is updated to indicate the preview status as active. If the user indicates that she does not wish to receive preview listings, then the method ends at operation 166.

It will be noted that information stored in the user database 77 may be utilized for a variety of purposes, such as generating the status of a user. The status of a user, in turn, may determine the level of services the user is entitled to receive. Some of the examples of differentiated levels of services may include enhanced or abbreviated customer support service, an option to preview items listings not available to the general public, differentiated limits on the amount of trading the user can conduct within the network-based marketplace, and differentiated levels of insurance offerings. These differentiated levels of services may be utilized, for example, to reward users with good reputation or users who have conducted a predetermined amount of business within the network-based marketplace. Conversely, these differentiated levels of services may be utilized to deter undesirable behavior within the network-based marketplace. For example, the amount of trading a user can conduct within the network-based marketplace may be restricted for those users with poor reputation utilizing the restriction module 84. Similarly, users with poor reputation may not be eligible to an enhanced level of insurance offering, where those users of preferred status may be offered an enhanced level of insurance offering utilizing insurance module 85. The system 75 may be configured such that a user is provided with information regarding his/her status and with information regarding the criteria utilized by the system 75 to determine the status of a user.

Furthermore, the system 75 may be configured such that an appropriate level of service a user is entitled to be determined in accordance with one or more business metrics in addition to (or instead of) the user's status. Business metrics may utilize information gathered by the transaction processor 78 and/or stored in the user database 77. Furthermore, the transaction processor 78 may be configured to facilitate the creating of the business metrics.

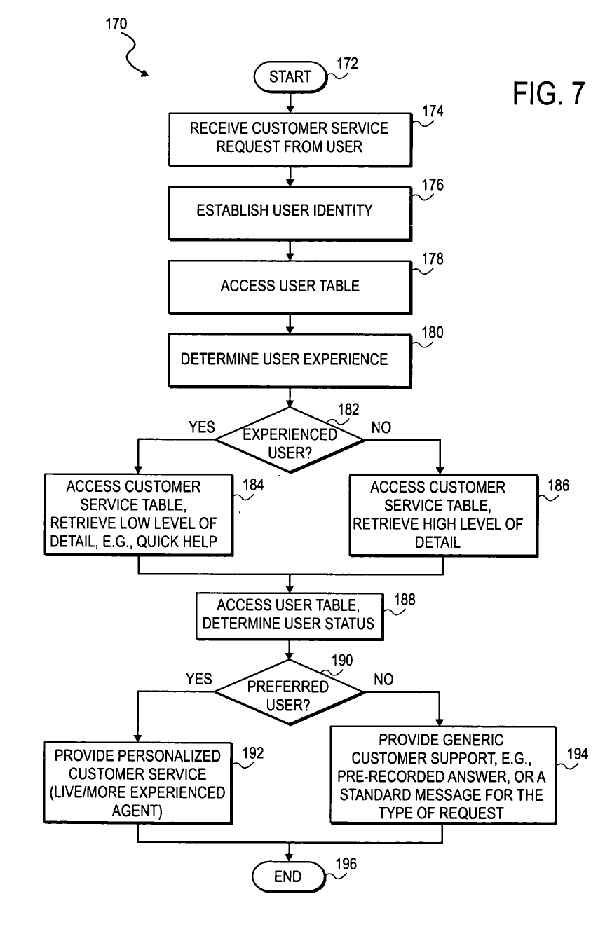

FIG. 7 illustrates a method 170 of providing differentiated customer service. The method 170 starts at operation 172. Upon receipt of a customer service request from a user at operation 174, the system 75 establishes the user's identity at operation 176, which may be accomplished by accessing the user table 92 and initiating the login sequence. At operation 180, the user's experience level is determined. If the user status table 114 indicates that the user has a status of an experienced user at operation 182, the user services module 80 accesses the customer support table 116 and retrieves a low level of detail (e.g., quick help) at operation 184. If it has been determined at operation 182 that the user does not have a status of an experienced user, then the user services module 80 may access the customer support table 116 and retrieves a high level of detail information at operation 186. Upon accessing user table 92 at operation 188, the user services module 80 determines the user status. If the user has a status of a preferred user, which is determined at operation 190, then personalized customer service information is provided to the user. Personalized customer service may include, for example, live customer service by a more experienced agent. Personalized customer service is provided at operation 192. If the user's status is not a preferred user, then generic customer support is provided at operation 194. The generic customer support may include, for example, a prerecorded answer or a standard message appropriate for a particular type of request. The method 170 concludes at operation 196.

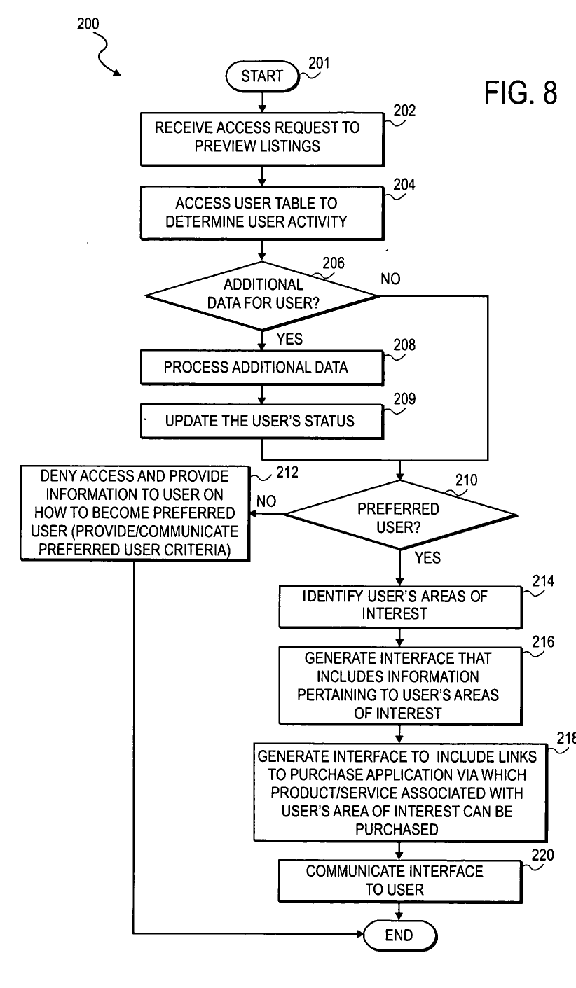

FIG. 8 is a flow chart illustrating a method 200 to provide a user interface to a user in order to enable the user to receive preview listings. The method 200 commences at operation 201. The system 75 receives a request from a user to receive preview listings at operation 202. At operation 204, the system 75 accesses the user table 92 to determine the user's status. The system 75 may further determine, at operation 206, whether there is additional data associated with the user available within the system 75 that needs to be processed. If it is determined, at operation 206, that such data is available, such data is processed within the system 75 at operation 208, and the user's status is updated at operation 209 according to the results obtained at operation 208. If there is no additional data to be processed, the status differentiator 82 determines whether the user is a preferred user at operation 210. If the user is not a preferred user, the access to the preview listings is denied and the user may optionally receive a notification and information on how to become a preferred user. This is done at operation 212. The user may be provided with the requirements to achieve the status of a preferred user. At operation 214, the system 75 attempts to identify the user's areas of interest in order to provide the relevant preview listings. Once the user's areas of interest are identified at operation 214, the system 75 generates an interface that may include information pertaining to the user's areas of interest at operation 216. At operation 218, the interface is generated to include the links to purchase applications via which product service associated with the user's area of interest can be purchased. At operation 220, the interface is communicated to the user.

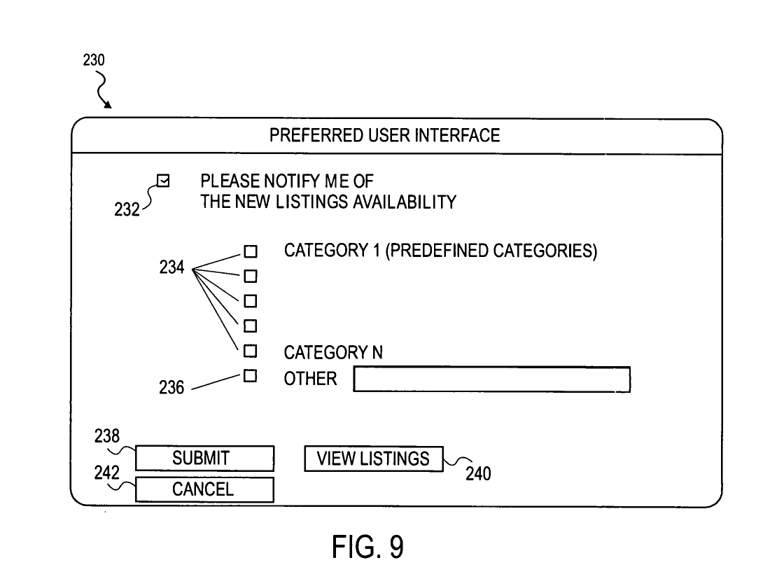

FIG. 9 is an exemplary user interface for a preferred user. This interface is identified by reference number 230. Check box 232 is utilized to indicate whether a user wishes to be notified of the new listings availability. Check boxes 234 constitute a list of categories. The categories can be predefined and selected by the users. In one exemplary embodiment, these categories may reflect the user's areas of interest. When the user is unable to select a category from the predefined categories associated with the check boxes 234, a check box 236 may be utilized along with a data entry field 237 to include a category of interest that is not available on the screen. The user may then attempt to view the available listings by actuating a button 240. The user may, alternatively, submit a request to be notified of the new listings'availability via a button 238 or the user may cancel the request by actuating a cancel button 242.

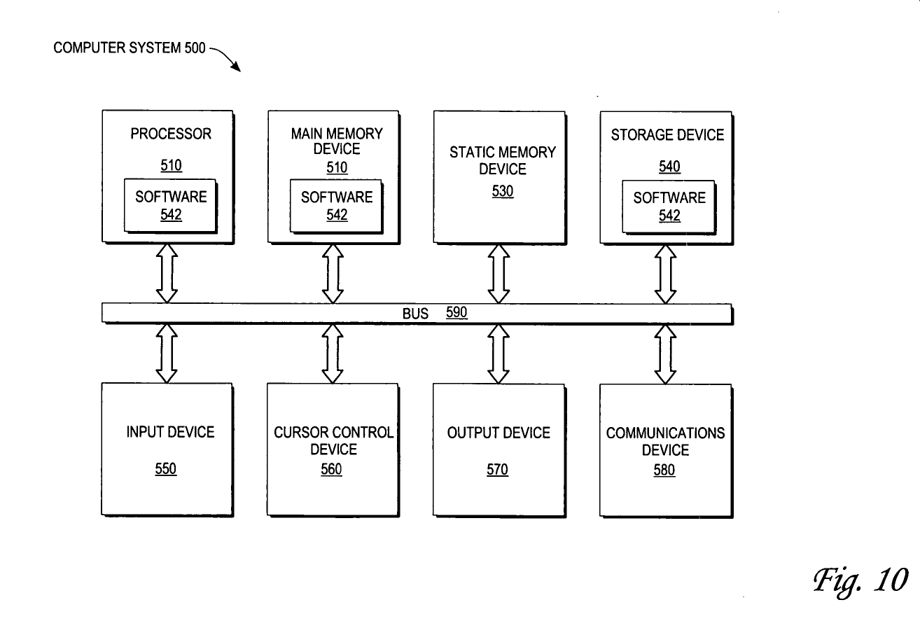

FIG. 10 illustrates a computer system 500 within which a set of instructions (e.g., software) may be executed for causing client computers and server computers mentioned above to perform the methods of the present invention.

The computer system 500 includes, a processor 510, a main memory device 520, a static memory device 530, a storage device 540 that further includes software 542, an input device 550, a cursor control device 560, an output device 570 and a communications device 580, all of which communicate with each other via a bus 590 and are connected as shown in the figure. In alternative embodiments, computer system 500 may comprise a network router, a network switch, a network bridge, a personal digital assistant (PDA), a cellular telephone, a Web appliance or any machine capable of executing a sequence of instructions that specify actions to be taken by that machine.

Processor 510 is, for example, a central processing unit (CPU) that processes the instructions of software 542. In an alternative embodiment, multiple processors 510 may be used in a multi-processor configuration. Main memory device 520 is, for example, conventional random access memory (RAM) or other dynamic storage device, and may be used for storing temporary variables or other intermediate information during execution of instructions by processor 510. Static memory 530 is, for example, read only memory (ROM) or other static storage device for storing static information and instructions for processor 510.

Storage device 540 is, for example, a hard disk drive, a floppy disk drive, or a compact disk drive that includes a machine-readable medium on which is stored software 542 embodying any one, or all, of the methods of the present invention.

Software 542 is also shown to reside, completely or at least partially, within main memory device 520 and/or within processor 510. Software 542 may be installed from a machine-readable medium, such as a floppy disk, a CD-ROM, and a DVD, and may further be transmitted or received via communications device 580. The term “machine-readable medium” may include any medium that is capable of storing or encoding a sequence of instructions for execution by processor 510 and that cause computer system 500 to perform any one of the methods of the present invention. The term “machine-readable medium” may also include solid-state memories, optical and magnetic disks, and carrier wave signals.

Computer system 500 has processing power (i.e., processor 510), memory capacity (i.e., memory device 520), and storage capacity (i.e., storage device 530) sufficient to run software 532 that embodies the operations of the methods of the present invention.

Input device 550 is a device capable of inputting data into computer system 500, such as a keyboard that includes alphanumeric and other keys. Cursor control device 560 is, for example, a mouse, a trackball, or cursor direction keys for communicating direction information and command selections to processor 510 and for controlling cursor movement on output device 570. Output device 570 is a device capable of outputting data from computer system 500, such as a video monitor or printer. Communications device 580 is, for example, a modem or a network adapter that enables and controls the exchange of data between computer system 500 and an external network (not shown), such as an intranet or the Internet. Bus 590 is a communication mechanism for communicating information via transmission media such as coaxial cables, copper wire and fiber optics. Transmission media may also take the form of electromagnetic or acoustic waves, such as those generated during radio and infrared data communications. Bus 590 enables information to be communicated among the various elements of computer system 500 to which it is connected.

In an exemplary operation, the methods of the present invention are provided by computer system 500 in response to processor 510 executing software 542 in main memory device 520. Software 542 may be read in from storage device 540. Execution by processor 510 of the sequences of instructions of software 542 in main memory device 520 causes processor 510 to perform the operations of the methods of the present invention. In response to output from output device 570, a user may input data via input device 550 and control the cursor position via cursor control device 560. Communications device 580 controls the exchange of data with any externally connected network, while bus 590 communicates data among the elements of computer system 500 to which it is connected.

In alternative embodiments, hard-wired circuitry may be used in place of or in combination with software instructions to implement the invention. Thus, embodiments of the invention are not limited to any specific combination of hardware circuitry and software.

Thus, method and apparatus to facilitate differentiated levels of service in a network-based marketplace has been described. Although the present invention has been described with reference to specific exemplary embodiments, it will be evident that various modifications and changes may be made to these embodiments without departing from the broader scope and spirit of the invention. Accordingly, the specification and drawings are to be regarded in an illustrative rather than a restrictive sense.

1. A system to facilitate differentiated levels of service in a network-based marketplace, the system including:
a transaction monitor to monitor activity of a user with respect to a network-based marketplace;
a status generator to generate a status within the network-based marketplace, for the user based at least partially on the monitored activity; and
a user service module to provide service within the network-based marketplace to the user in accordance with the determined status of the user.

2. The system of claim 1, wherein the user service module is dynamically to prioritize a level of service within the network-based marketplace for the user in accordance with one or more business metrics.

3. The system of claim 1, including a restriction module to limit an amount of trading the user can conduct in accordance with the user's status.

4. The system of claim 1, including an insurance module to assign different levels of insurance to the user in accordance with the user's status.

5. The system of claim 1, wherein the transaction monitor includes:
a collection and storage module to collect user data reflecting activity of the user, and to store the user data within a database; and
a customer score generator to automatically generate a customer score utilizing the user data.

6. The system of claim 5, wherein the collection and storage module is to receive feedback information associated with a performance of the user responsive to completion of the transaction.

7. The system of claim 5, wherein the user data includes a geographic location of the user.

8. The system of claim 1, wherein the transaction monitor is to receive transaction value information pertaining to the transaction responsive to completion of the transaction.

9. The system of claim 5, wherein the customer score generator is to:
update a total number of transactions parameter according to the user data;
update a feedback score parameter according to the user data;
update a value of transactions amount according to the user data; and
update a transaction frequency parameter.

10. The system of claim 1, wherein the service is at least one of a group of a customer support service and a preview service.

11. The system of claim 1, wherein the status of the user is at least one of a group of a preferred customer and an experienced customer.

12. The system of claim 11, including a status differentiator to establish the status of the user responsive to the user service module receiving a service request from the user for a customer support service, wherein the user service module is to provide personalized response to the user if the status of the user is a preferred customer status.

13. The system of claim 12, wherein the user service module is to provide an abbreviated response to the user if the status of the user is an experienced customer status.

14. The system of claim 12, wherein the user service module is to provide an abbreviated response to the user if the status of the user is not a preferred customer status.

15. The system of claim 11, wherein the user service module is to invite the user to preview one or more online sale items responsive to identifying the user as a preferred customer, the one or more online sale items not being available for preview to the general public.

16. The system of claim 15, wherein the status differentiator is to establish the status of the user responsive to the user service module receiving a service request from the user to preview the one or more online sale items, wherein the user service module is to enable the user to preview the one or more online sale items if the status of the user is a preferred customer status.

17. A method to facilitate differentiated levels of service in a network-based marketplace, the method including:
monitoring activity of a user with respect to a network-based marketplace;
determining a status, within the network-based marketplace, for the user based at least partially on the monitored activity; and
providing service within the network-based marketplace to the user in accordance with the determined status of the user.

18. The method of claim 17, wherein the providing of the service within the network-based marketplace to the user being in accordance with one or more business metrics.

19. The method of claim 17, including limiting the amount of trading the user can conduct in accordance with the determined status of the user.

20. The method of claim 17, including assigning different levels of insurance to the user in accordance with the determined status of the user.

21. The method of claim 17, wherein the monitoring of the activity of the user includes:
collecting and storing within a database user data reflecting activity of the user; and
automatically generating a customer score utilizing the user data.

22. The method of claim 21, wherein the collecting of the user data includes receiving feedback information associated with a performance of the user responsive to completion of a transaction.

23. The method of claim 21, wherein the user data includes a geographic location of the user.

24. The method of claim 17, wherein the monitoring of the activity of the user includes receiving transaction value information pertaining to a transaction responsive to completion of the transaction.

25. The method of claim 21, wherein the generating of the customer score includes:
updating a total number of transactions parameter according to the user data;
updating a feedback score parameter according to the user data;
updating a value of transactions amount according to the user data; and
updating a transaction frequency parameter.

26. The method of claim 17, wherein the service is at least one of a group of a customer support service and a preview service.

27. The method of claim 17, wherein the status of the user is at least one of a group of a preferred customer and an experienced customer.

28. The method of claim 27, including:
receiving a service request from the user for a customer support service;
responsive to the service request, establishing the status of the user; and
if the status of the user is a preferred customer status, providing personalized response to the user.

29. The method of claim 28, including providing an abbreviated response to the user if the status of the user is a preferred customer status.

30. The method of claim 28, including providing an abbreviated response to the user if the status of the user is an experienced customer status.

31. The method of claim 27, including:
responsive to identifying the user as a preferred customer, inviting the user to preview one or more online sale items, the one or more online sale items not being available for preview to the general public.

32. The method of claim 31, including:
receiving a request from the user to preview the one or more online sale items;
responsive to the service request, establishing the status of the user; and
if the status of the user is a preferred customer status, enabling the user to preview the one or more online sale items.

33. A method to facilitate differentiated levels of service in a network-based marketplace, the method including:
means for monitoring activity of a user with respect to a network-based marketplace;
means for determining a status, within the network-based marketplace, for the user based at least partially on the monitored activity; and
means for providing service within the network-based marketplace to the user in accordance with the determined status of the user.

34. A machine-readable medium having stored thereon data representing sets of instructions which, when executed by a machine, cause the machine to:
monitor activity of a user with respect to a network-based marketplace;
determine a status, within the network-based marketplace, for the user based at least partially on the monitored activity; and
provide service within the network-based marketplace to the user in accordance with the determined status of the user.
